(19) United States
(12) Patent Application Publication
(10) Pub. No.: US 2001/0030235 A1
(43) Pub. Date: Oct. 18, 2001

(54) Procedure for blocking certain international mobile subscriber identity ranges of prepaid and postpaid smart cards

(75) Inventors: Ralf Hedemann, Meerbusch (DE); Ralf Lubjahn, Meerbusch (DE)

Correspondence Address: Thomas C. Pontani, Esq., Cohen, Pontani, Lieberman & Pavane, 551 Fifth Avenue, Suite 1210, New York, NY, 10176, US

(73) Assignee: Atecs Mannesmann AG

(21) Appl. No.: 09/809,957

(22) Filed: Mar. 16, 2001

(30) Foreign Application Priority Data
Apr. 12, 2000 (DE) 100 19 164

(51) Int. Cl. G06K 7/08

(52) U.S. Cl. 235/451

(57) ABSTRACT

Independent use from each other of mobile-radio participant-identification cards and mobile-radio end devices sold as a package is made possible by a procedure and a mobile-radio end device that permit calling with the mobile-radio end device with the inserted mobile-radio participant-identification card only when certain digits of the IMSI of the mobile-radio participant-identification card lie within value ranges stored in the end device.

### BACKGROUND OF THE INVENTION

1. Field of the Invention

The present invention relates to a procedure and a mobile-radio end device for smart card checking in the end device.

2. Description of the Related Art

Subscriber Identity Module (SIM) cards, i.e., smart cards, are sold either as credit cards or as debit cards. The debit smart cards are prepaid cards and are often sold in a package with mobile-radio end devices (“handys”). The purchase of the package deal including the mobile-radio end device and the prepaid smart card is generally less expensive than the price for separately purchasing the mobile-radio end device and the prepaid smart cards. This provides an incentive for buying the package deal and then selling the prepaid smart card and the mobile-radio end device separately, to the detriment of the manufacturer of the mobile-radio end device and/or the service provider providing the mobile-radio service.

### SUMMARY OF THE INVENTION

An object of the present invention is to prevent a smart card and a mobile-radio end device purchased as a package and then sold separately from being used independently of one another.

The object according to the invention is met by a procedure for checking the validity of smart cards in a mobile-radio end device, including the steps of reading, by a mobile-radio end device, a number of data stored on an International Mobile Subscriber Identity of a smart card in the mobile-radio end device, comparing the number with value ranges stored in the mobile-radio end device, and allowing operation of the mobile-radio end device with the smart card by the mobile-radio end device when the data read from the smart card are within the value ranges stored in the mobile-radio end device.

The object according to the invention is also met by a mobile-radio end device including a receiving device operatively arranged for receiving a Subscriber Identity Module card, a reading device connected to the receiving device and operatively arranged for reading a number from data stored on the Subscriber Identity Module card received in the receiving device. A memory in the mobile-radio end device has allowed value range stored therein. A comparison device is arranged for comparing at least a portion of said number read by said reading device with the allowed value range stored in the memory. Furthermore, the mobile-radio end device has a means for allowing operation of the mobile-radio end device only when the number read by the reading device is within the allowed value range in the memory.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a table showing the digits of an International Mobile Subscriber Identity number which may be used by the procedure of the present invention for blocking unauthorized use of a smart card; and

FIG. 2 is a block diagram of a mobile-radio end device according to an embodiment of the present invention.

### DETAILED DESCRIPTION OF THE PRESENTLY PREFERRED EMBODIMENTS

According to the present invention, a mobile-radio end device in which a Subscriber Identity Module (SIM) card, i.e., smart card, is inserted reliably determines whether the mobile-radio end device is operable with this card (i.e., to make a telephone call or to send a message via Short Message Service (SMS)) by checking certain ranges, i.e., digits 1 through 8, of the International Mobile Subscriber Identity (IMSI) of the smart card.

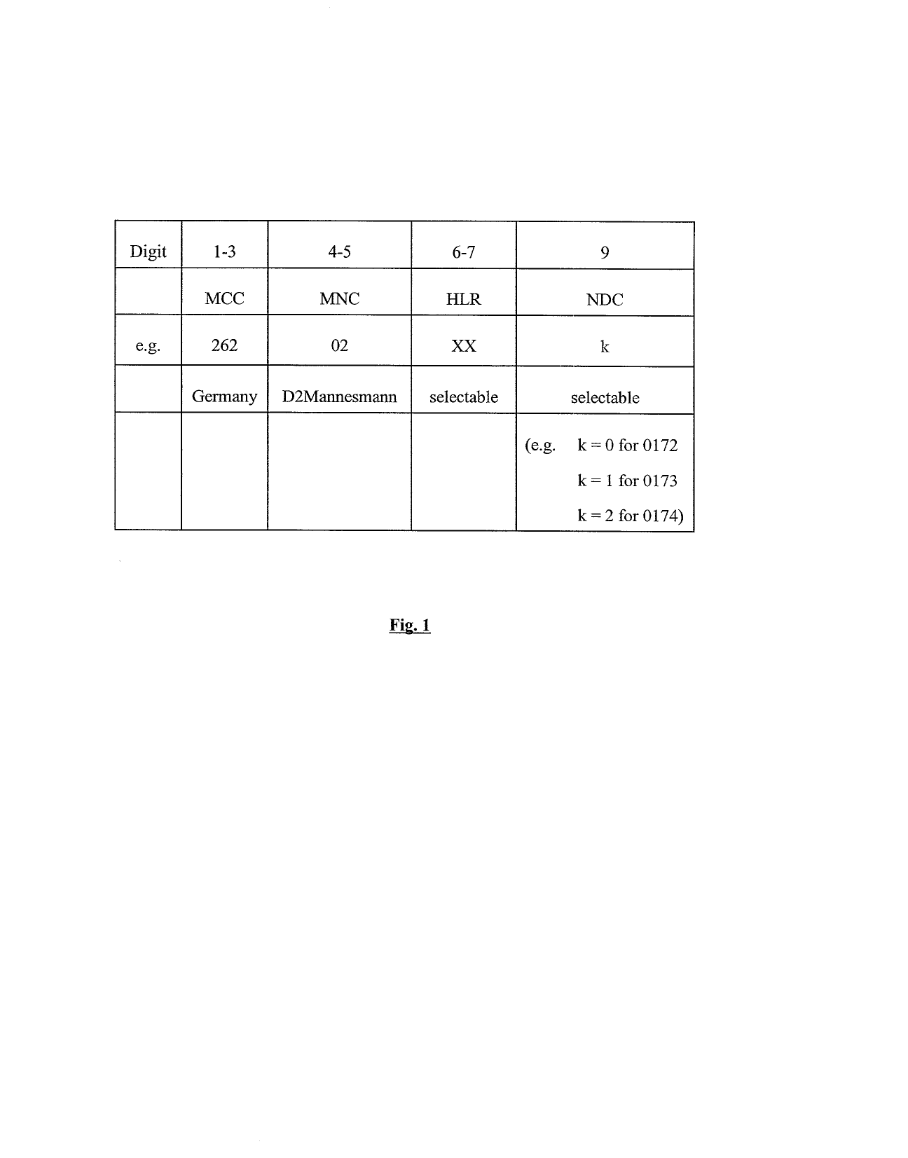

The IMSI includes various codes which can be checked. As shown in FIG. 1, digits 1-3 of the IMSI represent a Mobile Country Code (MCC) of the smart card. In the example shown in FIG. 1, the MCC is 262 which is the code for Germany. Digits 4-5 of the IMSI represent a Mobile Network Code (MNC) of the smart card. In the example of FIG. 1, the card is issued by Mannesmann so the MNC is 02 which is the D2Mannesmann network. Digits 6-7 of the IMSI represent the Home Location Register (HLR) where the information about the smart card is stored. Digit 8 represents a Network Destination Code (NDC).

When certain digits of the IMSI of the smart card (especially operator recognition and/or HLR identification and/or prefix identification) are checked, a reliable determination is made by the mobile-radio end device about whether the mobile-radio participant-identification card involves an HLR identification, NDC prefix identification and, in some cases, the presence of a GSM card (or UMTS card, etc.). One, several, or all of the digits may be checked. It is especially appropriate to check at least the MCC, the MNC, the HLR identification, and NDC identification. If only certain ranges of the HLR or NDC are used by the operator (with the MNC according to the SIM-IMSI), a mobile-radio end device may be produced such that it determines on the basis of these values whether a smart card in the mobile-radio end device is an authorized prepaid card. To make this determination, the value ranges of the MNC, MCC, HLR, and NDC to be stored in the mobile-radio end device are communicated to the producers of the mobile telephones by the operator of the mobile-radio network. It is important that the network operator has distinguished between debit and credit cards in regard to the HLRs through different ranges. That is, SIM cards from a particular HLR range are debit cards and another HLR range is used for credit cards.

A blocking may be provided by a block-unlock code (Master Code in connection with the smart cards). A complete blocking for a certain IMSI or a partial blocking may be implemented at various levels. For example, blocking for a particular MCC and MNC may be provided.

Various consequences could be provided for the case when a block-unblock code is input incorrectly, specifically, e.g., the device is “blocked” after several attempts, whereby removal of the block can only be provided in the producer's service cycle. Alternatively, e.g., the time interval after which the end device will again accept a code entry can be increased after each incorrect input.

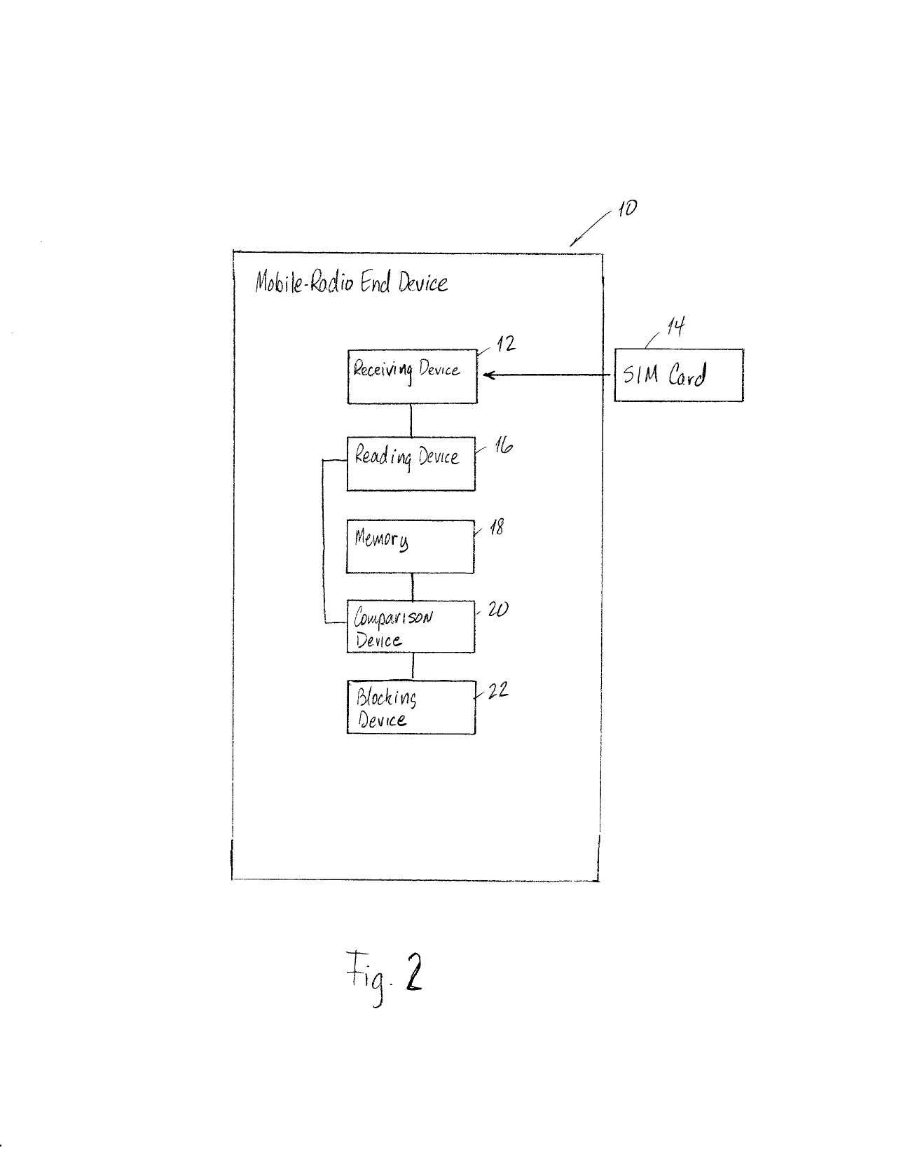

FIG. 2 shows a mobile-radio end device 10 according to an embodiment of the present invention. The mobile-radio end device includes a receiving device 12 for receiving a SIM card 14. A reading device 16 is connected to the receiving device 12 for reading at least a portion of data, i.e., the IMSI, from the SIM card 14. A memory 18 stores the allowable values of the data read from the IMSI and a comparison device 20 compares the data read from the IMSI by the reading device 16 to the range of allowable values stored in the memory 18. If the read data is within the allowed ranges, a blocking device 22 allows operation of the mobile-radio end device 10. The blocking device 22 may also block the operation of the mobile-radio end device for all SIM cards after a predetermined time interval or a predetermined point in time.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A procedure for checking the validity of smart cards in a mobile-radio end device, comprising the steps of:
(a) reading, by a mobile-radio end device, a portion of data stored in an International Mobile Subscriber Identity of a smart card in the mobile-radio end device;
(b) comparing the at least a portion of data with allowed value range stored in the mobile-radio end device; and
(c) allowing operation of the mobile-radio end device with the smart card by the mobile-radio end device when the portion of data read from the smart card in said step (a) is within the allowed value range stored in the mobile-radio end device.

2. The procedure of claim 1, wherein the portion of data that the end device reads in said step (a) relates to whether the smart card is a GSM card and said step (c) comprises allowing operation of the mobile-radio end device when the data read from the smart card are within the allowed value range stored in the mobile-radio end device which indicates that the smart card is a GSM card.

3. The procedure of claim 1, wherein said step (a) comprises reading a mobile country code and a mobile network code of the International Mobile Subscriber Identity of the smart card and said step (c) comprises allowing operation with the smart card depending on the mobile country code and the mobile network code read in said step (a).

4. The procedure of claim 1, wherein said step (a) comprises reading a Home Location Register identification of the International Mobile Subscriber Identity on the smart card and said step (c) comprises allowing operation of the mobile-radio end device with the smart card depending on the Home Location Register identification read in said step (a).

5. The procedure of claim 1, wherein said step (a) comprises reading a Network Destination Code identification of the International Mobile Subscriber Identity on the smart card and said step (c) comprises allowing operation of the mobile-radio end device with the smart card depending on the Network Destination Code identification read in said step (a).

6. The procedure of claim 1, further comprising the step of storing the International Mobile Subscriber Identity of the smart in a different component of the mobile-radio end device that the value range to increase the security of the program for checking the digits.

7. A mobile-radio end device, comprising:
a receiving device operatively arranged for receiving a Subscriber Identity Module card;
a reading device connected to said receiving device and operatively arranged for reading a portion of data stored on the Subscriber Identity Module card received in said receiving device;
a memory having an allowed value range stored therein;
a comparison device for comparing at least a portion of said number read by said reading device with said allowed value range stored in said memory; and
means for allowing operation of said mobile-radio end device with the Subscriber Identity Module card only when said at least a portion of data read by said reading device is within said allowed value range in said memory.

8. The mobile-radio end device of claim 7, wherein said value of ranges stored in said memory comprises a value of ranges of only GSM cards and said means for allowing operation allows operation of said mobile-radio end device only when said Subscriber Identity Module card is a GSM card.

9. The mobile-radio end device of claim 7, wherein said portion of data read by said reading device comprises a mobile country code of an International Mobile Subscriber Identity of the Subscriber Identity Module card, said allowed value range comprises a range of allowable mobile country codes, and said means for allowing allows operation of said mobile-radio end device when said mobile country code read by said reading device is within the range of allowable mobile country codes.

10. The mobile-radio end device of claim 7, wherein said portion of data read by said reading device comprises a mobile network code of an International Mobile Subscriber Identity of the Subscriber Identity Module card, said allowed value range comprises a range of allowable mobile network codes, and said means for allowing allows operation of said mobile-radio end device when said mobile network code read by said reading device is within the range of allowable mobile network codes.

11. The mobile-radio end device of claim 7, wherein said portion of data read by said reading device comprises a Home Location Register of an International Mobile Subscriber Identity of the Subscriber Identity Module card, said allowed value range comprises a range of allowable Home Location Registers, and said means for allowing allows operation of said mobile-radio end device when said Home Location Register read by said reading device is within the range of allowable Home Location Registers.

12. The mobile-radio end device of claim 7, wherein said portion of data read by said reading device comprises a prefix identification of an International Mobile Subscriber Identity of the Subscriber Identity Module card, said allowed value range comprises a range of allowable prefix identifications, and said means for allowing allows operation of said mobile-radio end device when said prefix identification read by said reading device is within the range of allowable prefix identifications.

13. The mobile-radio end device of claim 7, wherein said means for allowing further comprises means for blocking operation of said mobile-radio end device with any Subscriber Identity Card after one of a predetermined time interval and a predetermined point in time.

14. The mobile-radio device of claim 7, wherein said means for allowing is arranged in a component of said mobile-radio device other than said memory.

15. The mobile-radio end device of claim 7, wherein the operation allowed by said means for allowing includes speech telephony.

16. The mobile-radio end device of claim 7, wherein said operation allowed by said means for allowing includes receiving and sending of short messages.
